(19) United States
(12) Patent Application Publication
(10) Pub. No.: US 2026/0328425 A1
(43) Pub. Date: Oct. 22, 2026

(54) HEATING, VENTILATION AND AIR CONDITIONING (HVAC) FIELD DEVICE, AS WELL AS A METHOD AND COMPUTER PROGRAM PRODUCT FOR OPERATING AN HVAC FIELD DEVICE

(71) Applicant: BELIMO HOLDING AG, Hinwil (CH)

(72) Inventor: Manuel PIJORR, Meisterschwanden (CH)

(73) Assignee: BELIMO HOLDING AG, Hinwil (CH)

(21) Appl. No.: 19/484,158

(22) PCT Filed: Apr. 18, 2024
(86) PCT No.: PCT/EP2024/060614

§ 371 Date: Nov. 13, 2025

(30) Foreign Application Priority Data
May 16, 2023 (CH) CH000521/2023

(51) Int. Cl. F24F 11/64; F24F 11/88

(52) U.S. Cl. CPC F24F 11/64; F24F 11/88; F24F 2221/36

(57) ABSTRACT

A Heating, Ventilation and Air Conditioning (HVAC) field device includes a housing. an HVAC functional device including a sensor that measures a physical quantity of a system and/or includes an actuator for actuating a drivingly coupled actuated part, an extension interface, and an electronic circuit coupled to the HVAC functional device and the extension interface. The electronic circuit performs a validation of an add-on identifier, the add-on identifier corresponding to an add-on device attachable to the extension interface, and enables exchange of a data signal between the HVAC field device and the add-on device via the extension interface following a successful validation of the add-on identifier and/or blocks exchange of the data signal between the HVAC field device and the add-on device via the extension interface in the absence of successful validation of the add-on identifier.

### FIELD OF THE INVENTION

The present invention relates to a Heating, Ventilation and Air Conditioning (HVAC) field device, a system comprising an HVAC field device, a method of operating an HVAC field device, a computer program product comprising instructions for operating an HVAC field device and a computer-readable medium having stored thereon instructions of a computer program product for operating an HVAC field device.

### BACKGROUND OF THE INVENTION

Due to the fact that individuals reportedly spend approximately 90% of their time in indoor environments, Heating, Ventilation, and Air Conditioning (HVAC) systems have assumed a crucial role in everyday life and have a significant impact on people's well-being and comfort. HVAC systems in the field of Heating, Ventilation, and Air Conditioning usually encompass a fluid transportation system that comprises one or more fluid transportation circuits, with at least one of the fluid transportation circuits being coupled to a heat exchanger designed to facilitate the transfer of thermal energy to or from the environment to be regulated via a fluid that circulates within the fluid transportation system.

To regulate the flow of fluid to or from the heat exchanger and hence control the quantity of thermal energy transferred, the heat exchanger is connected to the fluid transportation system through one or more regulating devices, such as valves and dampers. The regulating devices are actuated by HVAC field devices, in particular, HVAC actuators that include motorized HVAC actuators coupled to the regulating device(s). In the realm of HVAC, HVAC actuators typically consist of an electric motor, which is mechanically coupled (via gears and/or other mechanical coupling) to the actuated part, i.e., the regulating device. The HVAC actuators are electrically controlled by HVAC controllers, specifically an electronic circuit of HVAC controller(s). Additionally, various HVAC sensors may be utilized to assess environmental parameters like humidity, temperature, CO₂ or dust particle levels. Furthermore, HVAC sensors may be employed to ascertain operational parameters of various components of an HVAC system, such as the actuated position of an actuated part, the operational state of an HVAC actuator (e.g., online/standby/offline), operating temperature, error state, etc.

HVAC systems commonly comprise an HVAC controller configured to generate control signal(s) for operating the HVAC actuator(s) and/or process signals from the HVAC sensors. In typical HVAC applications, the HVAC controller(s) generate the control signals for the HVAC actuators according to various control algorithms (e.g. with regards to differential pressure, room temperature, flow of energy, etc.) to thereby actuate the actuators, such as to open and close a damper or an orifice of a valve to regulate the flow of fluid.

Certain control functions of HVAC systems may be performed from a remote server arranged remote from the controlled environment, the remote server comprising a computer program such as a Building Management System BMS to control and monitor a building's mechanical and electrical equipment. Furthermore, certain functions, in particular the commissioning and/or configuration of HVAC systems may be performed by means of portable devices, such as a general purpose mobile computing device (e.g. a smartphone, tablet, laptop, etc.) or a dedicated configuration tool.

In summary, devices of HVAC systems may be categorized into two categories by their location with respect to the controlled environment: remote devices (arranged remotely from the controlled environment) and field devices (located within the controlled environment or mechanically connected, e.g. by the fluid transportation system, to the controlled environment). Field devices implement one or more electrical and/or mechanical functions and/or other functions (e.g. hydraulic, optical) and comprise-but not limited to-actuators, sensors, or a combination thereof.

HVAC field device are devices hydraulically and/or mechanically connectable to at least part of the fluid transportation circuit(s) with fluid supply/return lines, such as pipes, ducts or ports of valves and/or dampers such as to regulate and/or measure parameters of fluid(s) flowing therethrough, parameters such as flow rate, temperature, humidity, pressure, viscosity and/or chemical composition. Alternatively, or additionally, HVAC field devices are connectable to other HVAC field device(s) such as to control and/or measure parameters thereof, such as valve position, as well as speed, current and voltage of actuator(s), as well as positions of flow regulating devices, such as valves and/or dampers, etc.

HVAC field devices for regulating flow (parameters) of fluid(s) are referred to as HVAC actuators. HVAC actuators typically comprise a motor, such as an electric motor, and a mechanical drive for drivingly connecting the electric motor to an actuated part such as a valve or damper. HVAC actuators typically further comprise an interface for receiving electrical power; control and/or configuration signals.

HVAC field devices for measuring parameters of fluid(s) are referred to as HVAC sensors. Furthermore, the term HVAC field device also encompasses HVAC field devices combining sensor and actuator functions, for both controlling and measuring parameters of fluid(s) or other HVAC field device(s).

With increasing complexity of HVAC systems, there is an ever increasing demand for a wide variety of field devices implementing various electrical and/or mechanical and/or thermal HVAC functions and/or other functions (e.g. hydraulic, optical). Even for the same function, a range of HVAC field devices are required to cover a wide array of use cases each characterized by different parameters. For example, for the mechanical function of actuating a valve or a damper, different variants of a certain type of HVAC actuator are required to cover a wide range of flow regulation by means of valves of different sizes, requiring different actuation forces (e.g. a torque ranging from 1 Nm up to 160 Nm or even more). Different variants of HVAC actuators are also required to cover different power supplies and also different actuation times. Furthermore, the nature of the controlled environment also leads to varying demands on the HVAC field devices. For example, special variants of HVAC field devices are needed to be suitable for use in harsh environments. In addition, depending on the architecture of the HVAC system, various variants of HVAC field devices are needed to cover the different types of connectivity requirements.

An effective approach for covering a wide range of HVAC field devices is made possible through modularization, whereby the functionality(s) of an HVAC field device is extended by the attachment of one or more add-on devices. This allows the same add-on devices to be deployed with different HVAC field devices but also the same HVAC field device to be used in combination with various add-on devices. For example, the same add-on device comprising a communication interface (e.g. a wired or wireless data communication interface) may be attached to a sensor kind HVAC field device and/or an actuator kind HVAC field device. As a further example, the same HVAC field device of the sensor kind may be used in combination with an add-on device comprising a wired communication interface or another add-on device with a wireless communication interface without the need to design, manufacture respectively maintain separate wireless and wired versions of the HVAC field device. Modularization is known to be realized by providing HVAC field devices with an extension interface configured to receive a corresponding male or female type (hereinafter named mating) interface of the add-on devices. In particular, providing a standardized extension interface across a range of HVAC field devices enables a high degree of flexibility to combine them with add-on devices fitted with the matching interface. Despite the advantages of enhanced flexibility in combining different add-on devices with HVAC field devices, there are also some risks and drawbacks associated with such an unrestricted modularity.

For example, allowing modularity through the use of extension with add-on devices poses a specific drawback in that it opens up the possibility for incompatible, counterfeit, or unauthorized add-ons to be connected to the HVAC field devices, resulting in unsatisfactory, non-functional (due to incompatibility), and possibly even malicious combinations (e.g. counterfeit add-on devices being fitted to extract data from the HVAC field devices or the systems they are deployed in).

Hence, there is an unmet need to provide a solution enabling control over which particular add-on device may be functionally combined with a particular HVAC field device while retaining the advantages of modularity through the use of extension with add-on devices.

### SUMMARY OF THE INVENTION

It is an object of embodiments disclosed herein to provide an HVAC field device, a system comprising an HVAC field device, a method of operating an HVAC field device, a computer program product comprising instructions for operating an HVAC field device and a computer-readable medium having stored thereon instructions of a computer program product for operating an HVAC field device which overcome one or more of the disadvantages of the prior art. According to the present disclosure, this object is achieved by the features of the independent claims.

In addition, further advantageous embodiments follow from the dependent claims and the description.

In particular, it is an object of embodiments disclosed herein to provide an HVAC field device enabling control over which particular add-on device may be functionally combined with a particular HVAC field device while retaining the advantages associated with providing the HVAC field device with a (standardized) extension interface for receiving add-on devices.

Specifically, it is an object of embodiments disclosed herein to provide an HVAC field device having an extension interface configured for exchange of data signals with an attached add-on device but at the same time safeguard the HVAC field device from unwarranted exchange of data signals.

In the context of the present disclosure, the wording “functional combination” between an HVAC field device and an add-on device refers to an attachment of the add-on device with the HVAC field device followed by enablement of exchange of data signal(s) between the HVAC field device and the add-on device on the basis of validation of the add-on identifier.

This object is addressed according to embodiments disclosed herein by an HVAC field device comprising a housing, an HVAC functional device, an extension interface, and an electronic circuit coupled to the HVAC functional device and the extension interface. Depending on the kind of HVAC field device, the HVAC functional device comprises a sensor configured to measure a physical quantity of a system-in particular an HVAC system-such an HVAC field device being referred to as an HVAC field device of the sensor kind. Alternatively, or additionally, the HVAC functional device comprises an actuator for actuating a drivingly coupled actuated part.

According to embodiments of the present disclosure, the actuator of the HVAC functional device comprises an electric motor arranged within the housing to drive an actuated part. On the other hand, the sensor of the HVAC functional device of the HVAC field device is configured to measure a parameter of the HVAC system, in particular an environmental parameter, such as a temperature, humidity, particulate matter PM and/or CO₂ level of an environment controlled by the HVAC system. Alternatively, or additionally, the sensor of the HVAC functional device is provided to measure operational parameters of various components of the HVAC system such as an actuated position of the actuated part and/or the operational state of the HVAC field device and/or other parameters of a system, such as a flow rate or differential pressure at locations of a liquid through a fluid transportation system.

According to embodiments, in particular in case of HVAC field devices of the actuator kind, the HVAC functional device is arranged within the housing. Alternatively, or additionally in particular in case of HVAC field devices of the sensor kind, the HVAC functional device is arranged—at least partially—outside the housing. According to embodiments, the electronic circuit comprises any one or a combination of: a central processing unit CPU, a microcontroller, a digital signal processor DSP; and/or a dedicated hardware circuitry, such as an ASIC or FPGA. Furthermore, according to embodiments, the electronic circuit comprises a memory comprising any one or a combination of: a volatile or non-volatile, optic, magnetic or semiconductor based data storage.

Within the present disclosure, the term “coupled” is to be interpreted as including both direct and indirect connections between functional and/or structural elements. Specifically, the coupling of electronic components encompasses both direct and indirect electrical connections, which may be accomplished using relay, amplifier, filter, isolation (e.g., galvanic isolation), or similar devices. Similarly, the coupling of mechanical components, such as the actuator being drivingly coupled to an actuated part, is to be construed as encompassing both direct mechanical linkages as well as indirect mechanical linkages, such as those that utilize an axle, a joint, a clutch, or similar components. Furthermore, the coupling of communication components is to be interpreted as including both direct and indirect communicative connections, which may be achieved through the use of one or more switching, routing, gateway, buffering, filtering, firewall, or other data communication devices.

In order to enable control over which particular add-on device may be functionally combined with a particular HVAC field device, the electronic circuit is configured to perform a validation of an add-on identifier corresponding to an add-on device. Furthermore, the electronic circuit is configured to enable exchange of data signal(s) between the HVAC field device and the add-on device only following a successful validation of the add-on identifier. Alternatively, or additionally, the electronic circuit is configured to block exchange of data signal(s) between the HVAC field device and the add-on device via the extension interface in the absence of successful validation of the add-on identifier.

It is a further object of embodiments disclosed herein to provide a method of operating an HVAC field device allowing control over which particular add-on device may be functionally combined with a particular HVAC field device while retaining the advantages associated with providing the HVAC field device with a (standardized) extension interface for receiving add-on devices.

This object is addressed according to embodiments disclosed herein by a method of operating an HVAC field device comprising the steps of performing a validation of an add-on identifier corresponding to an add-on device attachable to the extension interface of the HVAC field device and enabling, by the electronic circuit of the HVAC field device, exchange of data signal(s) between the HVAC field device and the add-on device following a successful validation of the add-on identifier and/or blocking, by the electronic circuit of the HVAC field device, exchange of data signal(s) between the HVAC field device and the add-on device in the absence of the successful validation of the add-on identifier.

According to the present disclosure, enabling exchange of data signal(s) between the HVAC field device and the add-on device comprises:
Enabling receipt and/or transmission of electric signals via the extension interface to respectively from an attached add-on device;
Converting, by the electronic circuit, of electric signals received from an attached add-on device via the extension interface into data signals and/or converting, by the electronic circuit of data signals into electric signals to be transmitted to an attached add-on device via the extension interface.

According to embodiments, enabling exchange of data signal(s) between the HVAC field device and the add-on device comprises processing the data signal(s)-after and before conversion from respectively conversion into electrical signals, according to one or more data exchange algorithms.

According to embodiments, enabling exchange of data signal(s) between the HVAC field device and the add-on device comprises installment, by the electronic circuit following a successful validation of the add-on identifier, of a digital certificate and digitally signing data signal(s) to the add-on device attached to the HVAC field device. Alternatively, or additionally, the electronic circuit verifies data signal(s) from the add-on device attached to the HVAC field device using the digital certificate.

According to embodiments, enabling exchange of data signal(s) between the HVAC field device and the add-on device comprises installment, by the electronic circuit following a successful validation of the add-on identifier, of a cryptographic key and encrypting data signal(s) to the add-on device attached to the HVAC field device. Alternatively, or additionally, the electronic circuit decrypts data signal(s) from the add-on device attached to the HVAC field device using the cryptographic key.

On the other hand, according to the present disclosure, blocking exchange of data signal(s) between the HVAC field device and the add-on device comprises one or more of:
Blocking receipt and/or transmission of electric signals via the extension interface to respectively from an attached add-on device; and/or
Discarding of electric signals received from an attached add-on device via the extension interface; and/or
Converting, by the electronic circuit, of electric signals received from an attached add-on device via the extension interface into data signals and discarding all data signals except for data signals representative of the add-on identifier.

According to embodiments, the data signal(s) represent configuration and/or control data and/or operation data related to the HVAC field device, in particular of the HVAC functional device. Configuration data includes configuration parameters such as motor speed, closing time, closing torque, opening time, opening torque, valve type, etc. Control data includes values such as a set position, speed, angle, flow rate, pressure, etc. for controlling the HVAC functional device. The operation data includes values such as number of cycles, number of movements, maximum travel angle, minimum travel angle of an actuator of the HVAC functional device. In HVAC applications where the HVAC functional device comprises a sensor, such as flow sensors, pressure sensors, temperature sensors, humidity sensors, air quality sensors, rotation sensors, position sensors, etc., the configuration data includes configuration parameters such as a target value of flow rate, a set value of altitude for adjusting the measurement of a flow sensor, etc. In the context of the present disclosure, the term “successful validation”—with respect to a successful validation of the add-on identifier—refers to the step of verifying that the add-on identifier is valid. On the other hand, “absence of successful validation of the add-on identifier” refers to the state when the validity of the add-on identifier is not verified. Hence, “absence of successful validation of the add-on identifier” comprises both the state when the validity of the add-on identifier has not yet been verified, but also the state when the validity of the add-on identifier has been verified with the conclusion that the add-on identifier is not valid.

According to embodiments disclosed herein, the step of performing a validation of the add-on identifier comprises one or more of:
verifying the add-on identifier against record(s) of valid identifiers;
verifying whether the add-on identifier is valid using a validation algorithm;
verifying the add-on identifier against record(s) of valid identifiers specific for the particular HVAC field device to which the add-on device is attached (referred to as compatibility check);
verifying that the add-on identifier is valid for the particular HVAC field device to which the add-on device is attached using a validation algorithm;
verifying a digital certificate corresponding to the add-on device using a validation algorithm.

According to embodiments, the record(s) of valid identifiers comprise list(s) of individual valid add-on identifiers, and/or range(s) of valid add-on identifiers. The record(s) of valid identifiers specific for the particular HVAC field device comprise list(s) of individual valid add-on identifiers, and/or range(s) of valid add-on identifiers in combination with list(s) of individual HVAC field devices, types, ranges and/or series of HVAC field devices which may be operated in combination with an add-on device identified by the respective add-on identifier.

According to embodiments, the add-on identifier is determined either by the HVAC field device itself and/or by a computing device communicatively coupled to the HVAC field device.

According to embodiments disclosed herein, the HVAC afield device comprises an identification device coupled to and/or comprised by the electronic circuit, whereby the electronic circuit is configured to determine an add-on identifier corresponding to an add-on device, upon (i.e. immediately and/or shortly after) attachment of the add-on device to the extension interface of the HVAC field device. Alternatively, or additionally, the electronic circuit is configured to determine an add-on identifier corresponding to an add-on device, at any time after attachment of the add-on device to the extension interface of the HVAC field device, in particular upon (i.e. immediately and/or shortly after) a startup, commissioning, restart, wake-up from stand-by procedure of the HVAC field device.

According to embodiments, the identification device is configured to determine an add-on identifier corresponding to an add-on device attached to the extension interface by retrieving the add-on identifier from the attached add-on device-referred to as a pull method-electronically (by reading out the add-on identifier from a memory device of the add-on device) and/or optically (by reading a visual encoding of the add-on identifier, i.e. visibly provided on a housing of the add-on device) and/or by wireless electromagnetic means, i.e. by reading out the add-on identifier from a radio frequency identifier RFID part of and/or attached to the add-on device. Alternatively, or additionally, the identification device is configured to determine an add-on identifier corresponding to an add-on device attached to the extension interface by receiving the add-on identifier sent by the attached add-on device-referred to as a push method.

In order to avoid a functional combination of the HVAC field device with an add-on device other than the intended add-on device, according to embodiments, the identification device is configured such that only add-on identifiers of add-on devices attached to the extension interface can be determined. This may be implemented by electro-mechanical switches detecting physical attachment of the add-on device. Alternatively, or additionally, the identification device (such as an RFID reader, in particular an NFC reader) is arranged and/or configured such that a read-out of the add-on identifier is only possible from an add-on device attached to the extension interface of the HVAC field device.

According to further embodiments disclosed herein, the HVAC field device further comprises a communication interface coupled to the electronic circuit, such as a wired communication interface and/or a radio communication device. In particular, the communication interface comprises one or more of:
-A wired communication interface (such as an Ethernet, in particular a Power over Ethernet (POE), Single Pair Ethernet (SPE), a bus, in particular an MP Bus, BACnet, KNX or Modbus interface);
A Wide Area Network WAN communication circuit (such as GSM, LTE, 3G, 4G or 5G mobile communications circuit);
A Low-Power Wide Area Network (such as Narrowband Internet of Things (NB-IoT), Long Range LoRa/LoRaWAN, SigFox, or Long Term Evolution Category M1 (LTECatM1));
A local area network LAN communication circuit (such as Wireless LAN);
A short-range wireless communication circuit (such as Bluetooth®, Bluetooth low energy (BLE), Ultra-wideband (UWB), Thread and/or Zigbee); and/or
A close-range wireless communication circuit (such as Radio Frequency Identification (RFID) or a Near Field Communication (NFC)).

According to embodiments whereby the HVAC field device comprises a communication interface, for performing the validation of the add-on identifier, the electronic circuit being further configured to:
establish a data communication link with a computing device external to the HVAC field device, such as a mobile computing device (e.g. a smartphone, laptop computer);
receive data indicative of validation of the add-on identifier from the computing device;
perform the validation of the add-on identifier using the data indicative of validation of the add-on identifier received from the computing device.

In this case, a part of the validation of the add-on identifier is delegated by the HVAC field device to the computing device. For example, the data indicative of validation may comprise a result (i.e. “successful”, “unsuccessful”) of the validation of the add-on identifier. The generation of the data indicative of validation by the computing device is described below with reference to a system comprising an HVAC field device and a computing device.

According to embodiments whereby the HVAC field device comprises both an identification device for determining the add-on identifier and a communication interface for establish a data communication link with a computing device, the HVAC field device is configured to transmit (i.e. at the request of the computing device and/or periodically and/or upon establishment of the data communication link the add-on identifier of an add-on device attached to the extension interface to the computing device for validation.

Alternatively, or additionally to determining the add-on identifier by the HVAC field device, according to embodiments the add-on identifier is determined by the computing device. The computing device is configured to determine—using an identification device—an add-on identifier corresponding to an add-on device. According to embodiments, the identification device of the computing device comprises an imaging device configured to capture a visual encoding of the add-on identifier (e.g. a barcode, a QR-code). Alternatively, or additionally the identification device of the computing device comprises wireless electromagnetic, such as an RFID reader, in particular an NFC reader configured to retrieve the add-on identifier from an RFID Tag, in particular an NFC device attached to and/or comprised by the add-on device.

In order to further increase the certainty that only valid add-on devices are functionally combined with an HVAC field device, according to embodiments disclosed herein, the HVAC field device is configured to re-determine and/or re-validate the add-on identifier corresponding to the add-on device at set intervals. Alternatively, or additionally, the HVAC field device is configured to re-determine and/or re-validate the add-on identifier corresponding to the add-on device upon receipt of a re-validation request from a communicatively coupled computing device. In order to address voluntary and/or involuntary loss of power of the HVAC field device, according to embodiments disclosed herein, the HVAC field device is configured to re-determine and/or re-validate the add-on identifier corresponding to the add-on device following a start-up of the HVAC field device. In this way it can be avoided that a valid add-on device is exchanged for an invalid add-on device while the HVAC field device is shut down.

In order to enable a so-called off-line operation of the HVAC field device while still maintaining certainty that only valid add-on devices are functionally combined with an HVAC field device, according to embodiments disclosed herein, the electronic circuit is further configured to store, in a memory of the HVAC field device, validation data comprising one or more of: a validation algorithm, a list of one or more valid identifiers, one or more ranges of valid identifiers, a list of invalid identifiers and/or one or more ranges of invalid identifiers, and to perform the re-validation of the add-on identifier using the validation data stored in the memory.

It is a further object of embodiments disclosed herein to provide a system comprising an HVAC field device allowing control over which particular add-on device may be functionally combined with a particular HVAC field device while retaining the advantages associated with providing the HVAC field device with a (standardized) extension interface for receiving add-on devices.

This further object is addressed by a system comprising an HVAC field device according to one of the embodiments disclosed herein and a computing device external to the HVAC field device. The computing device is configured to establish a data communication link with the HVAC field device, receive the add-on identifier from the HVAC field device and/or determine the add-on identifier corresponding to the add-on device attachable to the extension interface of the HVAC field device, perform validation of the add-on identifier and transmit data indicative of validation of the add-on identifier to the HVAC field device.

According to embodiments disclosed herein, the computing device is one or more of: a laptop computer, a smartphone device, a tablet computer, a dedicated configuration device, the computing device comprising a communication interface configured to establish a data communication link with a corresponding communication interface of the HVAC field device.

In order to enable (at least partially) centralizing the control over which particular add-on device may be functionally combined with a particular HVAC field device, according to embodiments disclosed herein, the computing device is configured to establish a further data communication link with a remote computer external to the computing device, transmit the add-on identifier to the remote computer, and receive from the remote computer, data indicative of validation of the add-on identifier. Alternatively, or additionally, the electronic circuit is further configured to:
establish a data communication link with a remote computer external to the HVAC field device, such as a mobile computing device (e.g. a smartphone, laptop computer);
receive data indicative of validation of the add-on identifier from the remote computer;
perform the validation of the add-on identifier using the data indicative of validation of the add-on identifier received from the remote computer.

According to embodiments, the remote computer is a computer system located in a different physical location than the HVAC field device and/or the computing device. The remote computer is communicatively connectable with the computing device through a network, such as the internet, using remote access software or protocols. is a remotely located server computer (e.g. through a mobile communications network).

The remote computer is one of or a combination of the following:
Virtual Private Server (VPS): a virtual machine that hosted on a remote server, allowing complete control over the operating system and installed software, as well as access to dedicated resources such as CPU, RAM, and storage. VPS is commonly used for web hosting, development, and testing.
A Cloud Server: a virtual machine that is hosted on a cloud platform, providing scalable and flexible resources, including computing power, storage, and networking, that can be easily adjusted based on the user's needs.
A Terminal Server: a computer allowing multiple users to access it simultaneously using remote access software, each user having their own session and run own applications, while sharing the resources of the server.
A Workstation: is a (high-end) computer optimized for performing complex tasks. Remote workstations allow users to access powerful computing resources from a remote location, enabling them to work on demanding tasks without the need for a physical workstation.

It is a further object of embodiments disclosed herein to provide a computer program product comprising instructions for operating an HVAC field device allowing control over which particular add-on device may be functionally combined with a particular HVAC field device while retaining the advantages associated with providing the HVAC field device with a (standardized) extension interface for receiving add-on devices.

This further object is addressed by a computer program product comprising instructions, which, when executed by an electronic circuit of an HVAC field device, causes the HVAC field device to carry out the method of operating an HVAC field device according to one of the embodiments disclosed herein.

The present disclosure further relates to a computer-readable medium having stored thereon instructions of the computer program product according one of the embodiments disclosed herein. According to embodiments, computer-readable medium comprises a non-volatile storage medium comprising but not limited to: an optical storage medium (e.g. CD, DVD, Blu-ray Disc), a magnetic storage medium (e.g. Magnetic tape, Hard disk drive) and/or a semiconductor-based storage medium (e.g. Solid State Drive, flash memory drive).

According to embodiments, the computer readable instructions are provided as a computer software program, a binary (executable), a firmware, an embedded application or as part of program logic of a Field Programmable Gate Array and/or an Application Specific Integrated Circuit ASIC.

According to embodiments disclosed herein, attachment of the add-on device enables processing of data signal(s) to and/or from the HVAC functional device according to communication protocols not supported by the electronic circuit of the HVAC field device. For example, while the electronic circuit of the HVAC field device only supports analog communication protocols, the add-on electronic circuit is configured to further support digital communication protocols (e.g. RS485, KNX, MP-Bus, I2C).

The present disclosure is advantageous as the HVAC field device can be flexibly deployed by itself, but its functionalities being extendible by attaching an add-on device, in particular by stacking. Furthermore, the add-on device can be deployed with various HVAC field devices depending on the specific use case. These advantageous effects greatly improve the versatility of the HVAC field devices while reducing the number of HVAC field devices that need to be manufactured to cover a wide spectrum of use cases.

According to embodiments of the present disclosure, processing sensor data and/or processing actuator data is performed by the add-on device by an application specific integrated circuit ASIC or a uC (microcontroller) (pre) configured for the particular HVAC functionality(s). Alternatively, or additionally, processing sensor data and/or processing actuator data is provided by the add-on electronic circuit using computer readable instructions executable by a processor of the add-on electronic circuit, for example a fully configurable uC (microcontroller).

According to embodiments disclosed herein, the extension interface of the HVAC field device is configured such as to mechanically align an add-on device upon being attached to the HVAC field device. For a better aligning effect, according to embodiments, the interface is tapered at its outer surfaces.

According to embodiments of the present disclosure, the interfaces comprise a recess, in particular a circumferential recess arranged on a first side of the housing of the respective HVAC field device respectively a corresponding (mating) protrusion, in particular a circumferential protrusion arranged on a second side of the housing of the respective HVAC field device.

According to embodiments disclosed herein, the extension interface is configured to mutually interlock with a corresponding add-on interface of the add-on device by an interface-fit upon the add-on device being stacked onto the HVAC field device, to thereby fixedly attach the devices to each other. The term fixedly attaching, as used herein, refers to attaching such that a release force is required to separate the fixedly attached devices, the release force exceeding forces applied to the devices under normal operation of the HVAC field device and/or the release force acting in a direction/manner different from forces applied on the HVAC field device under normal operation of the HVAC field device.

According to further embodiments, an adhesive and/or fastening means is provided to the interfaces for fixedly attaching the devices to each other upon being stacked. According to embodiments of the present disclosure, the fastening means comprise latches, screws or bolts in order to mechanically connect the devices. Alternatively, or additionally, the devices are welded together after being stacked, in particular by ultrasonic welding or laser welding.

According to the specific requirements on the HVAC field device, a sealant is provided at the interfaces to seal the devices together, with respect to humidity, dust or other sources of contamination.

According to embodiments disclosed herein, the add-on device(s) comprise one or more of:
-A processing device, such as a microcontroller or application specific integrated circuit (ASIC) for providing computing power to the HVAC field device;
A controller device, implementing HVAC control functions, such as a proportional (P), a proportional-integral (PI), a proportional-integral-derivative (PID), an integral (I) and/or a neural network based control;
A communication device, comprising a wired communication interface and/or a radio communication device—for providing communication functionalities to the HVAC field device. In particular, the communication device comprises one or more of:
   A wired communication interface (such as an Ethernet, in particular a Power over Ethernet PoE, Single Pair Ethernet SPE, a bus, in particular an MP Bus, BACnet, KNX or Modbus interface);
   A Wide Area Network WAN communication circuit (such as GSM, LTE, 3G, 4G or 5G mobile communications circuit);
   A Low Power Wide Area Network (such as Narrowband Internet of Things (NB-IoT), Long Range LoRa/LoRaWAN, SigFox, or Long Term Evolution Category M1 (LTECatM1));
   A local area network (LAN) communication circuit (such as Wireless LAN); A short-range wireless communication circuit (such as Bluetooth®, Bluetooth low
   A close-range wireless communication circuit (such as Radio Frequency Identification (RFID) or a Near Field Communication (NFC)).
An energy storage device, comprising a capacitive storage device and/or an electro-chemical storage device;
A sensor device, comprising one or more sensors for the measurement of a parameter of a system and/or of an environmental parameter (such as temperature, humidity, pressure, etc.);
An HVAC interface device, comprising a mechanical interface to a damper and/or pipe of an HVAC system;
A position feedback device of the actuated part;
An electrical power supply unit, for providing external electrical power to the HVAC field device, such as universal power supply units (24 VAC to 250 VAC/24 VDC-125 VDC), or power supply units for specific supply voltages;
A monitoring/service device, for performing specific service and data logging function(s); and/or
A display device.

In order to provide additional or redundant power supply, embodiments of the add-on device further comprise an add-on external electrical interface arranged on the housing for the transmission of electrical power.

In order to provide additional or redundant data signal connectivity, embodiments of the add-on device further comprise an add-on external electrical interface arranged on the housing for the transmission of data signal(s).

It is an objective of further embodiments to extend the HVAC functionalities of an HVAC field device so that data signal(s) and transmission of electrical power share the same electrical connections (Power-line communication PLC). This further objective is addressed in that the communication interface of the add-on HVAC field device is configured for transmission of data signal(s) and transmission of electrical power over same electrical connections.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings which show:

FIG. 1: a schematic block diagram of an HVAC field device according to an embodiment of the present disclosure, an add-on device being attached thereto;

FIG. 2: a schematic block diagram of system according to an embodiment of the present disclosure;

FIG. 3: a flow chart depicting steps of an embodiment of a method of operating an HVAC field device according to an embodiment of the present disclosure;

FIG. 4: a swim-lane diagram depicting steps of a further embodiment of a method of operating an HVAC field device according to the present disclosure;

FIG. 5: a swim-lane diagram depicting steps of a further embodiment of a method of operating an HVAC field device according to the present disclosure;

FIG. 6: a swim-lane diagram depicting steps of a further embodiment of a method of operating an HVAC field device according to the present disclosure;

FIG. 7: a swim-lane diagram depicting steps of a further embodiment of a method of operating an HVAC field device according to the present disclosure; and

FIG. 8: a swim-lane diagram depicting steps of a further embodiment of a method of operating an HVAC field device according to the present disclosure;

### DETAILED DESCRIPTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components, parts or steps.

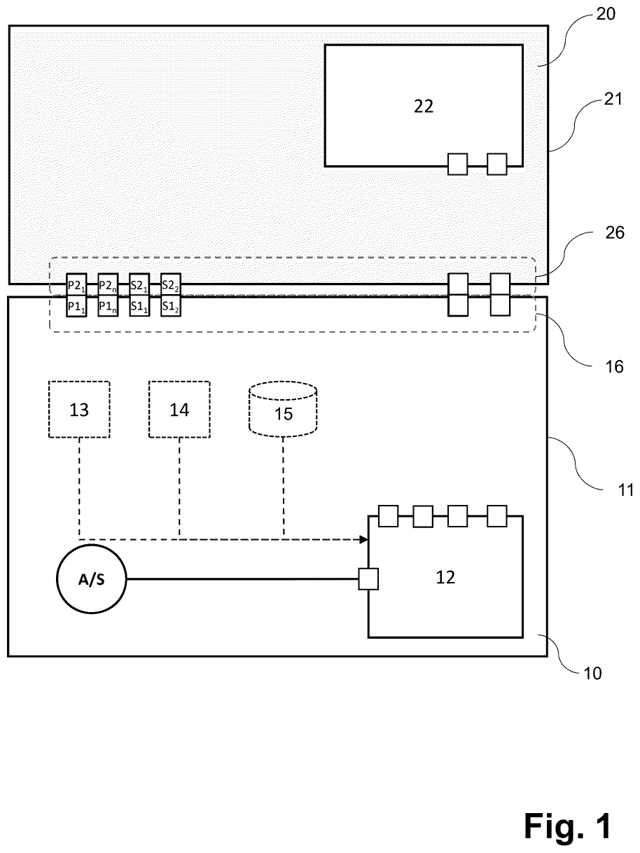

FIG. 1 shows a highly schematic block diagram of an embodiment of an HVAC field device 10 according to the present disclosure. As shown on the figure, the HVAC field device 10 comprises a housing 11, an HVAC functional device A/S, an extension interface 16 and an electronic circuit 12.

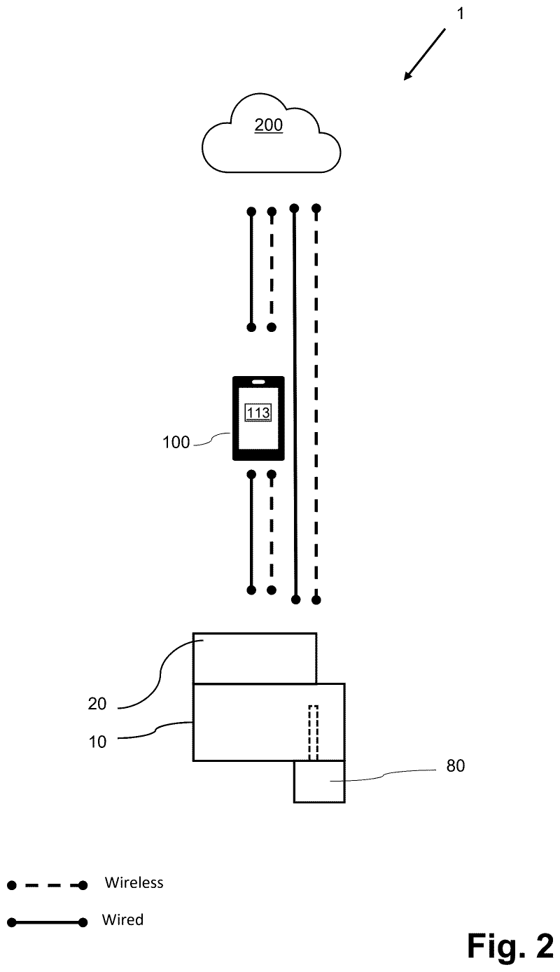

The HVAC functional device A/S comprises an actuator A such as an electric motor arranged within the housing 11 to drive an actuated part 80 (located outside the housing 11, see FIG. 2). Alternatively, or additionally the HVAC functional device A/S comprises a sensor S. The sensor S is arranged within the housing 11. Alternatively, or additionally, the sensor S is arranged outside the housing 11 and communicatively coupled to the HVAC field device 10. The sensor S of the HVAC field device 10 is configured to measure a physical quantity of a system, in particular an environmental parameter, such as a temperature, humidity, particulate matter (PM) and/or CO₂ level. Alternatively, or additionally, the sensor S of the HVAC field device 10 is provided to measure operational parameters of various components of the system 1 such as an actuated position of the actuated part 80 and/or the operational state of the HVAC field device and/or other parameters of the system 1 (see FIG. 2), such as a flow rate or differential pressure at locations of a liquid through a fluid transportation system.

The extension interface 16 is arranged on the housing 11 and provided to accommodate an add-on device 20, in particular by stacking, by connecting to a counterpart add-on interface 26 of the add-on device 20. According to embodiments disclosed herein, the extension interface 16 of the HVAC field device 10 is configured such as to mechanically align the add-on device upon being attached to the HVAC field device 10. For a better aligning effect, according to some embodiments, the interface is tapered at its outer surfaces.

According to some embodiments of the present disclosure, the interfaces may comprise a recess, in particular a circumferential recess arranged on a first side of the housing 11 of the respective HVAC field device 10 respectively a corresponding (mating) protrusion, in particular a circumferential protrusion arranged on a second side of the housing 11 of the respective HVAC field device 10.

According to embodiments disclosed herein, the extension interface is configured to mutually interlock with a corresponding interface of the add-on device 20 by an interface-fit upon the add-on device 20 being stacked onto the HVAC field device 10, to thereby fixedly attach the plurality devices to each other. The term “fixedly attaching”, as used herein, refers to attaching such that a release force is required to separate the fixedly attached devices, the release force exceeding forces applied to the devices under normal operation of the HVAC field device 10 and/or the release force acting in a direction/manner different from forces applied on the HVAC field device under normal operation of the HVAC field device 10.

According to even further embodiments, an adhesive and/or fastening means is provided to the interfaces for fixedly attaching the devices to each other upon being stacked. According to embodiments of the present disclosure, the fastening means comprise latches, screws or bolts in order to mechanically connect the devices. Alternatively, or additionally, the devices are welded together after being stacked, in particular by ultrasonic welding or laser welding. According to the specific requirements on the HVAC field device 10, a sealant is provided at the interfaces to seal the devices together, with respect to humidity, dust or other sources of contamination.

The electronic circuit 12 comprises any one or a combination of: a central processing unit (CPU), a physical or virtual computer, a local and/or remote portable, desktop and/or server computer, a cloud-based server or software as a service, and/or a dedicated hardware circuitry, such as an ASIC or FPGA.

Furthermore as shown with dashed lines, according to embodiments, the electronic circuit 12 comprises a memory 15. The memory 15 comprises one or more of different types of memory devices, including random access memory (RAM), read-only memory (ROM), flash memory, and magnetic storage devices. Random access memory (RAM) is a type of memory device that stores data temporarily. Read-only memory (ROM) is a type of memory device that stores data permanently. Flash memory is a type of non-volatile memory device that can be erased and reprogrammed. Magnetic storage devices, such as hard disk drives, use magnetic fields to store data. According to embodiments, the memory 15 is configured for storing validation data comprising one or more of: a validation algorithm, a list of one or more valid identifiers, one or more ranges of valid identifiers, a list of invalid identifiers and/or one or more ranges of invalid identifiers, and to perform the re-validation of the add-on identifier using the validation data stored in the memory 15.

As shown with dashed lines, the HVAC field device 10 optionally comprises an identification device 13 coupled to and/or comprised by the electronic circuit 12, whereby the electronic circuit 12 is configured to determine an add-on identifier corresponding to the add-on device 20, upon (i.e. immediately and/or shortly after) attachment of the add-on device 20 to the extension interface 16 of the HVAC field device 10. According to embodiments, the identification device 13 is configured to determine the add-on identifier corresponding to the add-on device 20 attached to the extension interface 16 by retrieving the add-on identifier from the attached add-on device 20—referred to as a pull method—electronically (by reading out the add-on identifier from a memory device of the add-on device 20) and/or optically (by reading a visual encoding of the add-on identifier, i.e. visibly provided on a housing of the add-on device) and/or by wireless electromagnetic means, i.e. by reading out the add-on identifier from a radio frequency identifier RFID part of and/or attached to the add-on device 20. Alternatively, or additionally, the identification device 13 is configured to determine the add-on identifier corresponding to the add-on device 20 attached to the extension interface 16 by receiving the add-on identifier sent by the attached add-on device 20—referred to as a push method.

As shown with dashed lines, the HVAC field device 10 optionally further comprises a communication interface 14 coupled to the electronic circuit 12, such as a wired communication interface and/or a radio communication device. In particular, the communication interface comprises one or more of:
A wired communication interface (such as an Ethernet, in particular a Power over Ethernet (POE), Single Pair Ethernet (SPE), a bus, in particular an MP Bus, BACnet, KNX or Modbus interface);
A Wide Area Network (WAN) communication circuit (such as GSM, LTE, 3G, 4G or 5G mobile communications circuit);
A Low-Power Wide Area Network (such as Narrowband Internet of Things (NB-IoT), Long Range LoRa/LoRaWAN, SigFox, or Long Term Evolution Category M1 (LTECatM1));
A local area network (LAN) communication circuit (such as Wireless LAN);
A short-range wireless communication circuit (such as Bluetooth®, Bluetooth low energy (BLE), Ultra-wideband (UWB), Thread and/or Zigbee); and/or
A close-range wireless communication circuit (such as Radio Frequency Identification (RFID) or a Near Field Communication (NFC)).

FIG. 1 also shows a highly schematic block diagram of the add-on device 20. The add-on device 20 comprises a housing 21, an add-on interface 26, and an add-on electronic circuit 22 coupled to the add-on interface 26. The add-on device 20 is configured to be attached-in particular by stacking (on top of each other or side by side)-to the HVAC field device 10 according to one of the embodiments disclosed herein. In particular, the add-on interface 26 is arranged on the housing 21 such that it connects with the extension interface 16 of the HVAC field device 10 when the add-on device 20 is attached to the HVAC field device 10.

The add-on device is configured and provided to extend the functionality of an HVAC field device 10.

As it can be seen, the add-on device 20 is constructed correspondingly to the HVAC field device 10, in particular, the add-on interface 26 is constructed as a counterpart of the extension interface 16 of the HVAC field device 10. According to the embodiment shown, the add-on interface 26 comprises signal connector(s) S2₁₋ₙ attachable to corresponding signal connector(s) S1₁₋ₙ of the extension interface 16 of the HVAC field device 10. In order to supply the add-on device 20 with electrical power, the add-on interface 26 comprises power connectors P2₁₋ₙ for the transmission of electrical power, the electronic circuit 12 being c with the power connectors P1₁₋ₙ of the add-on interface 16 when the add-on device 20 is fixedly attached to the HVAC field device 10.

According to embodiments disclosed herein, the add-on device comprises one or more of:
A processing device, such as a microcontroller or application specific integrated circuit (ASIC) for providing computing power to the HVAC field device;
A controller device, implementing HVAC control functions, such as a proportional (P), a proportional-integral (PI), a proportional-integral-derivative (PID), an integral (I) and/or a neural network based control;
A communication device, comprising a wired communication interface and/or a radio communication device—for providing communication functionality to the HVAC field device. In particular, the communication device comprises one or more of:
   A wired communication interface (such as an Ethernet, in particular a Power over Ethernet (POE), Single Pair Ethernet (SPE), a bus, in particular an MP Bus, BACnet, KNX or Modbus interface);
   A Wide Area Network (WAN) communication circuit (such as GSM, LTE, 3G, 4G or 5G mobile communications circuit);
   A Low-Power Wide Area Network (such as Narrowband Internet of Things (NB-IoT), Long Range LoRa/(LoRaWAN), SigFox, or Long Term Evolution Category M1 (LTECatM1));
   A local area network (LAN) communication circuit (such as Wireless LAN);
   A short-range wireless communication circuit (such as Bluetooth®, Bluetooth low energy (BLE), Ultra-wideband (UWB), Thread and/or Zigbee; and/or
   A close-range wireless communication circuit (such as Radio Frequency Identification (RFID) or a Near Field Communication (NFC)).
An energy storage device, comprising a capacitive storage device and/or an electro-chemical storage device;
A sensor device, comprising one or more sensors for the measurement of a parameter of a system and/or of an environmental parameter (such as temperature, humidity, etc.);
An HVAC interface device, comprising a mechanical interface to a damper and/or pipe of an HVAC system;
A position feedback device of the actuated part;
An electrical power supply unit, for providing external electrical power to the HVAC field device, such as universal power supply units (24 VAC to 250 VAC/24 VDC-125 VDC), or power supply units for specific supply voltages;
A monitoring/service device, for performing specific service and data logging function(s); and/or
A display device.

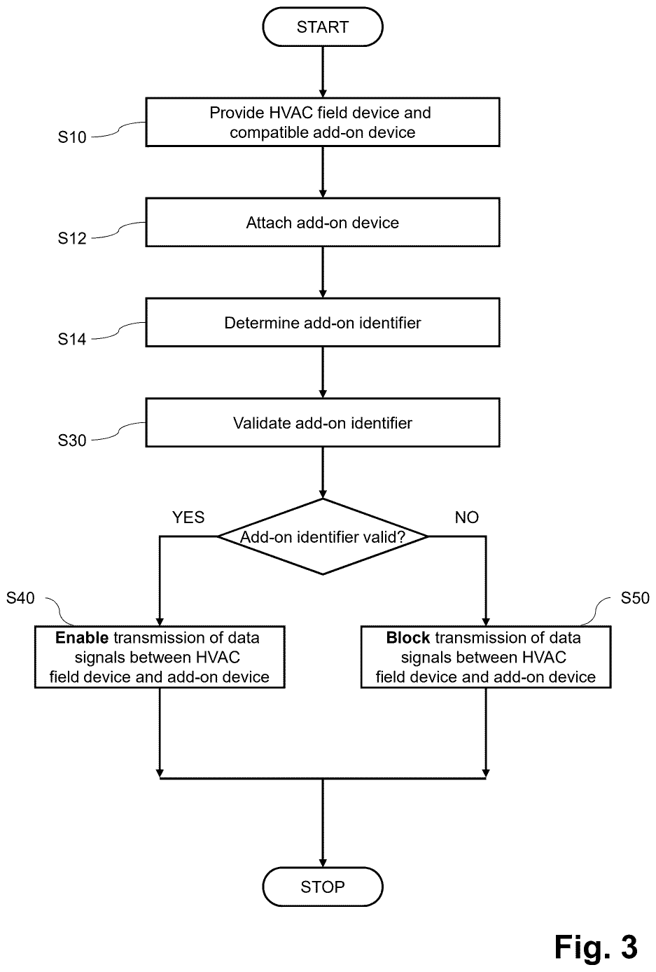

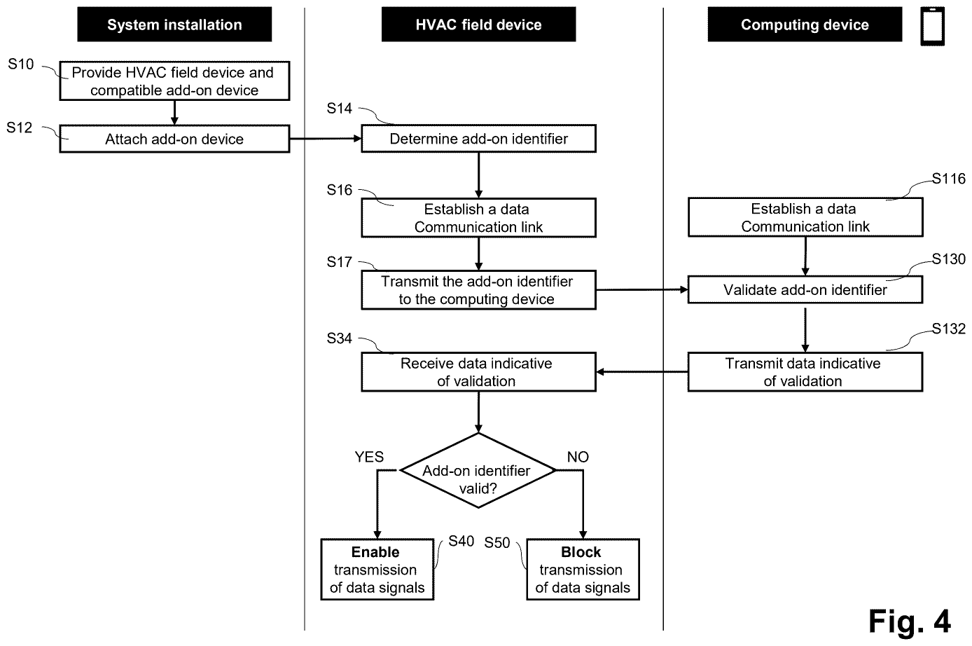

The interaction between the HVAC field device 10 and the add-on device 20 are described below with reference to FIGS. 3 and 4.

FIG. 2 shows a schematic block diagram of system 1 according to an embodiment of the present disclosure. As illustrated, the system 1 comprises an HVAC field device 10 according to one of the embodiments disclosed herein and a computing device 100 external to the HVAC field device 10. According to embodiments disclosed herein, the computing device 100 is one or more of: a laptop computer, a smartphone device, a tablet computer, a dedicated configuration device, the computing device 100 comprising a communication interface configured to establish a data communication link with the corresponding communication interface 14 of the HVAC field device 10. In some embodiments disclosed herein, the computing device may further comprise an identification module 113.

The HVAC field device 10 is configured to establish a data communication link with the computing device 100 to delegate at least a part of the validation of the add-on identifier to the computing device 100. The data communication link between the HVAC field device 10 and the computing device 100 is achieved by one or more of:
A wired communication (such as an Ethernet, in particular a Power over Ethernet (POE), Single Pair Ethernet (SPE), a bus, in particular an MP Bus, BACnet, KNX or Modbus interface);
A Wide Area Network (WAN) such as GSM, LTE, 3G, 4G or 5G mobile communications circuit;
A Low-Power Wide Area Network (such as Narrowband Internet of Things (NB-IoT), Long Range LoRa/(LoRaWAN), SigFox, or Long Term Evolution Category M1 (LTECatM1));
A local area network (LAN) communication (such as Wireless LAN);
A short-range wireless communication (such as Bluetooth®, Bluetooth low energy (BLE), Ultra-wideband (UWB), Thread and/or Zigbee); and/or
A close-range wireless communication (such as Radio Frequency Identification (RFID) or a Near Field Communication (NFC)).

The computing device 100 may-according to embodiments-be configured to establish a further data communication link with a remote computer 200 external to the computing device 100.

Alternatively, the HVAC field device 10 may be configured to establish a data communication link with the remote computer 200 without the need for a computing device 100 as an intermediary.

The further data communication link with the remote computer 200 is achieved by one or more of:
A wired communication (such as an Ethernet, in particular a Power over Ethernet (POE), Single Pair Ethernet (SPE), a bus, in particular an MP Bus, BACnet, KNX or Modbus interface);
A Wide Area Network (WAN) (such as GSM, LTE, 3G, 4G or 5G mobile communication);
A Low Power Wide Area Network (such as Narrowband Internet of Things (NB-IoT), Long Range LoRa/LoRaWAN, SigFox, or Long Term Evolution Category M1 (LTECatM1)); and/or
A local area network (LAN) communication (such Wireless LAN).

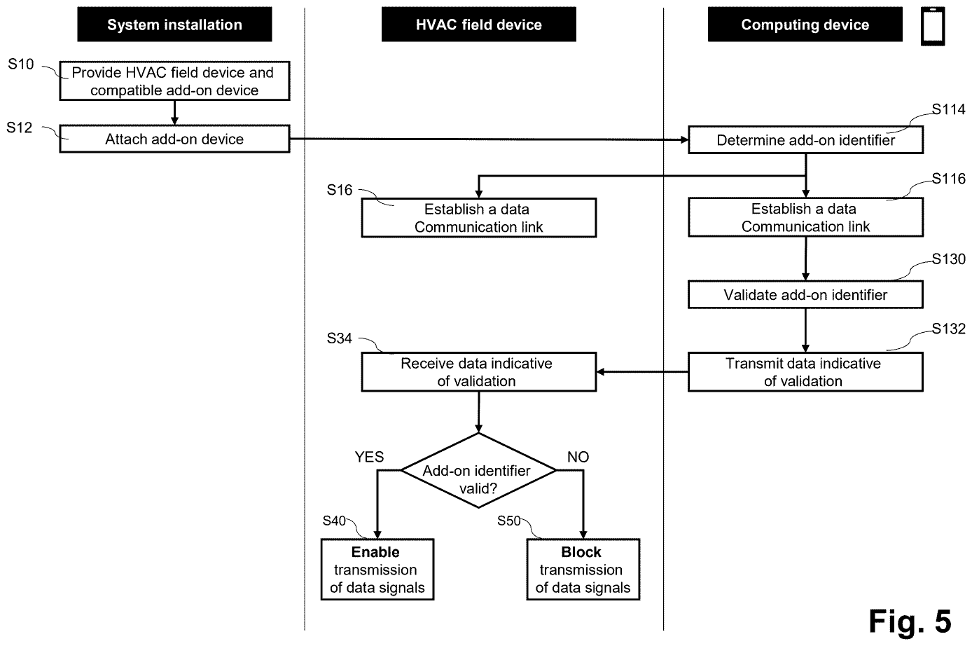

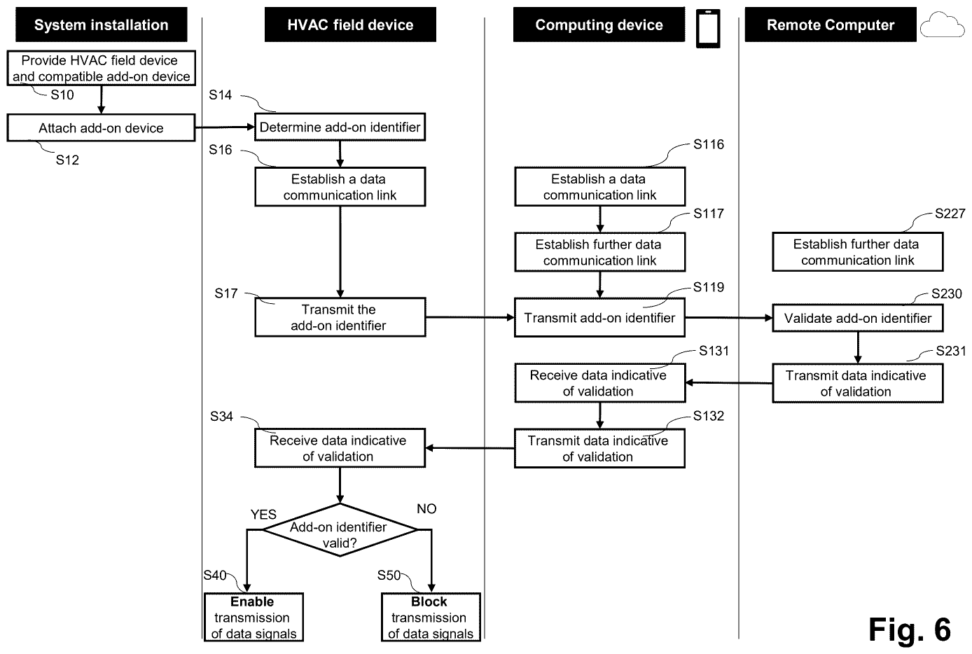

The interaction between the HVAC field device 10, the add-on device 20, the computing device 100 and optionally the remote computer 200 are described below with reference to the swim-lane diagrams of FIGS. 5 and 6.

FIG. 3 shows a flow chart depicting steps of an embodiment of a method of operating an HVAC field device 10 according to an embodiment of the present disclosure. In a first, preparatory step S10, an HVAC field device 10 is provided, the HVAC field device 10 comprising a housing 11, an HVAC functional device A/S, an extension interface 16, and an electronic circuit 12 coupled to the HVAC functional device A/S and the extension interface 16. Furthermore, an add-on device 20 is provided, the add-on device 20 comprising an add-on interface 26 arranged and configured to be attachable to the extension interface 16 of the HVAC field device 10.

Thereafter, in a step S12, the add-on device 20 is attached to the HVAC field device 10 by attachment of the add-on interface 26 of the add-on device 20 to the extension interface 16 of the HVAC field device 10. According to embodiments, the attachment causes the extension interface 16 to mutually interlock with the add-on interface 26 of the add-on device by an interface-fit, to thereby fixedly attach the devices to each other.

Following the preparatory steps, in a step S14, the HVAC field device 10 determines an add-on identifier corresponding to the add-on device 20, upon (i.e. immediately or shortly thereafter) attachment of the add-on device 20 to the extension interface 16 of the HVAC field device 10 using an identification device 13 coupled to and/or comprised by the electronic circuit 12. In particular, the HVAC field device 10 determines the add-on identifier corresponding to the add-on device 20 by reading out the add-on identifier from a radio frequency identification (RFID) unit attached to or part of the add-on device 20.

In a subsequent step S30, the electronic circuit 12 performs a validation of the add-on identifier corresponding to the add-on device 20.

Thereafter, if the validation of the add-on identifier is successful, in a step S40, the electronic circuit 12 enables exchange of data signal(s) between the HVAC field device and the add-on device 20.

According to embodiments, as part of step S40 of enabling exchange of data signal(s) between the HVAC field device 10 and the add-on device 20, the electronic circuit 12 enables receipt and/or transmission of electric signals via the extension interface 16 to, respectively from, the attached add-on device 20 and converts electric signals received from the attached add-on device 20 via the extension interface 16 into data signals. Alternatively, or additionally the electronic circuit 12 converts data signals into electric signals to be transmitted to an attached add-on device 20 via the extension interface 16. After conversion of electric signals from an attached add-on device 20 into data signals, the electronic circuit 12 processes the data signal(s) according to one or more data exchange algorithms. Furthermore, the electronic circuit 12 processes the data signal(s) according to one or more data exchange algorithms before their conversion into electrical signals to be transmitted (via the extension interface 16 and the add-on interface 26) to the add-on device 20.

In the absence of successful validation of the add-on identifier, in a step S50, the electric circuit 12 of the HVAC field device 10 blocks the transmission of data signals between the HVAC field device 10 and the add-on device 20. As part of step S50 of blocking exchange of data signal(s) between the HVAC field device 10 and the add-on device 20, the electronic circuit 12 discards all data signals originating from the add-on device 20 except for data signals representative of the add-on identifier.

FIG. 4 shows a swim-lane diagram depicting steps of a further embodiment of a method of operating the HVAC field device 10 according to the present disclosure, whereby part of the validation of the add-on identifier is delegated to a computing device 100 external to and communicatively coupled to the HVAC field device 10. According to this embodiment, following the preparatory steps S10 and S12, and step S14, in steps S16 (carried out by the HVAC field device 10) and S116 (carried out by the computing device 100), a data communication link is established between the HVAC field device 10 and the computing device 100. Thereafter, in a step S17, the electronic circuit 12 of the HVAC field device 10 transmits the add-on identifier (as determined in step S14) to the computing device 100. Thereafter, in a step S130, the computing device 100 then receives the add-on identifier from the HVAC field device and performs the validation of the add-on identifier. Thereafter, in a step S132, the computing device 100 transmits data indicative of validation of the add-on identifier to the HVAC field device 10, which, in a step S34 receives the data indicative of validation of the add-on identifier and enables or blocks transmission of data signal(s) between the HVAC field device and the add-on device 20 depending on whether or not the validation of the add-on identifier has been successful.

FIG. 5 shows a swim-lane diagram depicting steps of a further embodiment of a method of operating an HVAC field device 10 according to the present disclosure, whereby both the determination of the add-on identifier as well as part of the validation of the add-on identifier are delegated to a computing device 100 external to and communicatively coupled to the HVAC field device 10. According to this embodiment, following the preparatory steps S10 and S12, in a step S114, the computing device 100 determines—using its identification device 13—the add-on identifier corresponding to the add-on device 20. Before, after or simultaneous to the determination of the add-on identifier by the computing device 100, in steps S16 (carried out by the HVAC field device) and S116 (carried out by the computing device), a data communication link is established between the HVAC field device 10 and the computing device 100. In a step S130, the computing device 100 performs the validation of the add-on identifier. Thereafter, in step S132, the computing device 100 transmits data indicative of validation of the add-on identifier to the HVAC field device 10, which, receives the data indicative of validation of the add-on identifier and enables or blocks transmission of data signal(s) between the HVAC field device 10 and the add-on device 20 depending on whether or not the validation has been successful.

FIG. 6 shows a swim-lane diagram depicting steps of a further embodiment of a method of operating an HVAC field device 10 according to the present disclosure, whereby at least part of the validation of the add-on identifier is delegated by the computing device 100 to a remote computer 200, in order to facilitate a centralized control over which particular add-on device 20 may be functionally combined with a particular HVAC field device 10. In a step S117, carried out before, after or simultaneous with step S116 (FIG. 6 illustrating and embodiment whereby step S118 being carried out after step S116), the computing device 100 establishes a further data communication link with a remote computer 200 external to the computing device 100. In a step S227, corresponding to step S117, the remote computer 200 collaborates with the computing device 100 in establishing the further data communication link. As depicted in FIG. 6, following the preparatory steps S10, S12 and following step S14 of determining of the add-on identifier by the HVAC field device 10, following step S17 of transmitting the add-on identifier (as determined in step S14) to the computing device 100 and following step S117 of establishing the further data communication link with the remote computer 200, in a step S119, the computing device 100 transmits the add-on identifier to the remote computer 200. Subsequently, in a step S230, the remote computer 200 validates the add-on identifier and, in a step S231, transmits data indicative of validation of the add-on identifier to the computing device 100. After receiving—in a step S131—the data indicative of validation of the add-on identifier from the remote computer 200, in step S132, the computing device 100 transmits data indicative of validation of the add-on identifier to the HVAC field device 10, which, in step S34 receives the data indicative of validation of the add-on identifier and enables or blocks transmission of data signal(s) between the HVAC field device 10 and the add-on device 20 depending on whether or not the validation has been successful.

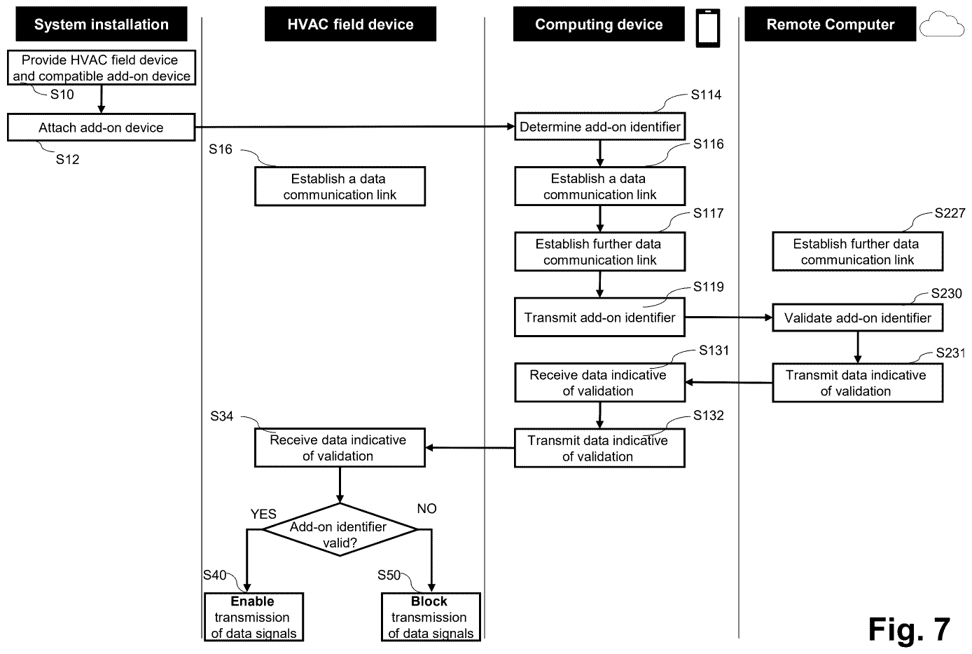

FIG. 7 shows a swim-lane diagram depicting steps of a further embodiment of a method of operating an HVAC field device 10 according to the present disclosure, whereby similarly to the embodiment illustrated in FIG. 6, at least part of the validation of the add-on identifier is delegated by the computing device 100 to the remote computer 200. In contrast to the embodiment illustrated in FIG. 6, in the embodiment illustrated in FIG. 7, the add-on identifier is determined by the computing device 100 in step S114. In a step S117, carried out before, after or simultaneous with step S116 (FIG. 7 illustrating and embodiment whereby step S118 being carried out after step S116), the computing device 100 establishes a further data communication link with the remote computer 200 external to the computing device 100. As depicted in FIG. 7, following the preparatory steps S10, S12, following step S114 of determining the add-on identifier by the computing device 100, following step S17 of transmitting the add-on identifier (as determined in step S14) to the computing device 100 and following step S117 of establishing the further data communication link with a remote computer 200, in a step S119, the computing device 100 transmits the add-on identifier to the remote computer 200. Subsequently, in a step S230, the remote computer 200 validates the add-on identifier and, in a step S231, transmits data indicative of validation of the add-on identifier to the computing device 100. The validation of the add-on identifier may be carried out as explained above. After receiving—in a step S131—the data indicative of validation of the add-on identifier from the remote computer 200, in step S132, the computing device 100 transmits data indicative of validation of the add-on identifier to the HVAC field device 10, which, in step S34 receives the data indicative of validation of the add-on identifier and enables or blocks transmission of data signal(s) between the HVAC field device 10 and the add-on device depending on whether or not the validation has been successful.

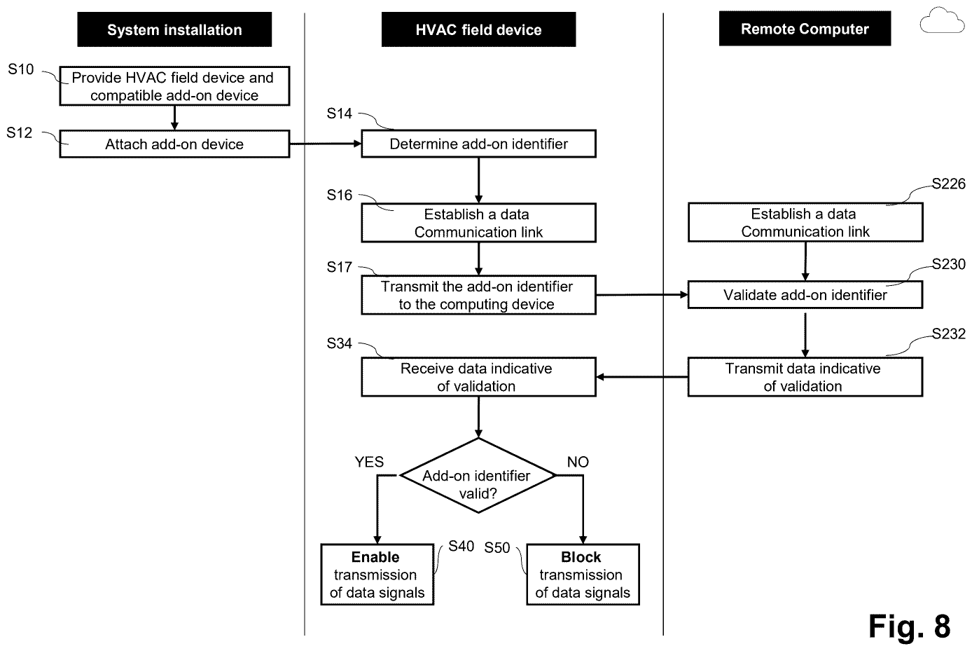

FIG. 8 shows a swim-lane diagram depicting steps of a further embodiment of a method of operating the HVAC field device 10 according to the present disclosure, whereby part of the validation of the add-on identifier is delegated to a remote computer 200 external to and communicatively coupled to the HVAC field device 10. According to this embodiment, following the preparatory steps S10 and S12, and step S14, in steps S16 (carried out by the HVAC field device 10) and S226 (carried out by the remote computer 200), a data communication link is established between the HVAC field device 10 and the remote computer 200. Thereafter, in step S17, the electronic circuit 12 of the HVAC field device 10 transmits the add-on identifier (as determined in step S14) to the remote computer 200. Thereafter, in a step S230, the remote computer 200 then receives the add-on identifier from the HVAC field device and performs the validation of the add-on identifier. Thereafter, in a step S232, the remote computer 200 transmits data indicative of validation of the add-on identifier to the HVAC field device 10, which, in a step S34 receives the data indicative of validation of the add-on identifier and enables or blocks transmission of data signal(s) between the HVAC field device 10 and the add-on device 20 depending on whether or not the validation of the add-on identifier has been successful.

### LIST OF REFERENCE NUMERALS

system 1
HVAC field device 10
housing (of HVAC field device) 11
HVAC functional device A/S
sensor (of HVAC functional device) S
actuator (of HVAC functional device) A
electronic circuit (of HVAC functional device) 12
identification device (of HVAC functional device) 13
communication interface 14
memory 15
extension interface (of HVAC functional device) 16
signal connectors (of HVAC functional device) S1₁₋ₙ
power connectors (of HVAC functional device) P1₁₋ₙ
add-on device 20
housing (of add-on device) 21
electronic circuit (of add-on device) 22
add-on interface (of add-on device) 26
signal connectors (of add-on device) S2₁₋ₙ
power connectors (of add-on device) P2₁₋ₙ
computing device 100
identification module (of computing device) 113
remote computer 200
actuated part 80

1. A Heating, Ventilation and Air Conditioning (HVAC) field device comprising:
a housing;
an HVAC functional device, the HVAC functional device comprising a sensor configured to measure a physical quantity of a system and/or comprising an actuator for actuating a drivingly coupled actuated part;
an extension interface; and
an electronic circuit coupled to the HVAC functional device and the extension interface, the electronic circuit being configured to:
perform a validation of an add-on identifier, the add-on identifier corresponding to an add-on device attachable to the extension interface; and
enable exchange of a data signal(s) between the HVAC field device and the add-on device via the extension interface following a successful validation of the add-on identifier and/or block exchange of the data signal(s) between the HVAC field device and the add-on device via the extension interface in the absence of successful validation of the add-on identifier.

2. The HVAC field device according to claim 1, further comprising an identification device coupled to and/or comprised by the electronic circuit, the identification device being configured to determine the add-on identifier corresponding to the add-on device upon and/or after attachment of the add-on device to the extension interface.

3. The HVAC field device according to claim 1- or 2, further comprising a communication interface coupled to the electronic circuit,
wherein, for performing the validation of the add-on identifier, the electronic circuit is further configured to:
establish a data communication link with a computing device and/or a remote computer external to the HVAC field device;
receive data indicative of validation of the add-on identifier from the computing device and/or the remote computer; and
perform the validation of the add-on identifier using the data indicative of validation of the add-on identifier received from the computing device and/or the remote computer.

4. The HVAC field device according to claim 1, wherein, the electronic circuit is further configured to re-determine and/or re-validate the add-on identifier corresponding to the add-on device at set intervals and/or upon receipt of a re-validation request and/or following a start-up of the HVAC field device.

5. The HVAC field device according to claim 4, further comprising a memory,
wherein the electronic circuit is further configured to:
store, in the memory, validation data comprising one or more of: an unlocking/locking algorithm, a validation algorithm, a list of one or more valid identifiers, one or more ranges of valid identifiers, a list of invalid identifiers and/or one or more ranges of invalid identifiers; and
perform the re-validation of the add-on identifier using the validation data stored in the memory.

6. A system comprising:
the HVAC field device according to claim 3; and
a computing device external to the HVAC field device, the computing device being configured to:
establish a data communication link with the HVAC field device;
receive the add-on identifier from the HVAC field device or determine the add-on identifier corresponding to the add-on device attachable to the extension interface of the HVAC field device;
perform validation of the add-on identifier; and
transmit data indicative of validation of the add-on identifier to the HVAC field device.

7. The system according to claim 6, wherein, for performing validation of the add-on identifier, the computing device is configured to:
establish a further data communication link with a remote computer external to the computing device;
transmit the add-on identifier to the remote computer; and
receive from the remote computer, data indicative of validation of the add-on identifier.

8. A method of operating a Heating, Ventilation and Air Conditioning (HVAC) field device comprising a housing, an HVAC functional device arranged within the housing, the HVAC functional device comprising a sensor configured to measure a physical quantity of a system and/or comprising an actuator for actuating a drivingly coupled actuated part, an extension interface, and an electronic circuit coupled to the HVAC functional device and the extension interface,
the method comprising:
performing, by the HVAC field device, a validation of an add-on identifier corresponding to an add-on device attachable to the extension interface; and
enabling, by the electronic circuit of the HVAC field device, exchange of a data signal(s) between the HVAC field device and the add-on device following a successful validation of the add-on identifier and/or blocking, by the electronic circuit of the HVAC field device, exchange of the data signal(s) between the HVAC field device and the add-on device in the absence of the successful validation of the add-on identifier.

9. The method according to claim 8, further comprising determining, by an identification device coupled to and/or comprised by the electronic circuit of the HVAC field device, the add-on identifier corresponding to the add-on device upon and/or after attachment of the add-on device to the extension interface.

10. The method according to claim 8, wherein performing the validation of the add-on identifier by the HVAC field device comprises:
establishing a data communication link between a communication interface of the HVAC field device and a computing device and/or a remote computer;
transmitting, by the HVAC field device, the add-on identifier to the computing device and/or the remote computer and/or determining the add-on identifier corresponding to the add-on device attachable to the extension interface of the HVAC field device using the computing device;
receiving, by the HVAC field device data indicative of validation of the add-on identifier from the computing device and/or the remote computer and
performing the validation of the add-on identifier using the data indicative of validation of the add-on identifier received from the computing device and/or the remote computer.

11. The method according to claim 10, further comprising:
establishing, by the computing device, a further data communication link with a remote computer;
transmitting, by the computing device, the add-on identifier to the remote computer;
receiving, by the computing device, from the remote computer, data indicative of validation of the add-on identifier; and
transmitting, by the computing device to the HVAC field device, the data indicative of validation of the add-on identifier.

12. The method according to claim 8, further comprising re-determining and/or re-validating the add-on identifier corresponding to the add-on device at set intervals and/or upon receipt of a re-validation request and/or following a start-up of the HVAC field device.

13. The method according to claim 12, further comprising:
storing, in a memory of the HVAC field device, validation data comprising one or more of: an unlocking/locking algorithm, a validation algorithm, a list of one or more valid identifiers, one or more ranges of valid identifiers, a list of invalid identifiers and/or one or more ranges of invalid identifiers; and
performing, by the electronic circuit of the HVAC field device the re-validation of the add-on identifier using the validation data.

14. A non-transitory storage medium, comprising computer-readable instructions, which, when executed by an electronic circuit of a HVAC field device, causes the HVAC field device to carry out the method according to claim 8.

15. The non-transitory storage medium according to claim 14, wherein performing the validation of the add-on identifier by the HVAC field device comprises:
establishing a data communication link between a communication interface of the HVAC field device and a computing device and/or a remote computer;
transmitting, by the HVAC field device, the add-on identifier to the computing device and/or the remote computer and/or determining the add-on identifier corresponding to the add-on device attachable to the extension interface of the HVAC field device using the computing device;
receiving, by the HVAC field device data indicative of validation of the add-on identifier from the computing device and/or the remote computer and
performing the validation of the add-on identifier using the data indicative of validation of the add-on identifier received from the computing device and/or the remote computer, and
wherein the computer-readable instructions comprise further instructions, which, when executed by a computing device, causes the computing device to:
establish, by the computing device, a further data communication link with a remote computer;
transmit, by the computing device, the add-on identifier to the remote computer;
receive, by the computing device, from the remote computer, data indicative of validation of the add-on identifier; and
transmit, by the computing device to the HVAC field device, the data indicative of validation of the add-on identifier.

16. (canceled)
